(19) United States
(12) Patent Application Publication
(10) Pub. No.: US 2011/0247856 A1
(43) Pub. Date: Oct. 13, 2011

(54) SHIELDED CABLE

(75) Inventors: Motoi MATSUDA, Kanuma-shi (JP); Katsumi KARUBE, Kanuma-shi (JP); Satoshi OKANO, Kanuma-shi (JP)

(73) Assignee: SUMITOMO ELECTRIC INDUSTRIES, LTD., Osaka (JP)

(21) Appl. No.: 13/069,094

(22) Filed: Mar. 22, 2011

(30) Foreign Application Priority Data
Apr. 8, 2010 (JP) 2010-089559

(51) Int. Cl. H01B 9/02

(52) U.S. Cl. 174/108

(57) ABSTRACT

There is provided a shielded cable wherein a metal coated resin tape is helically wound, whereby a plurality of signal cables are shielded, and no sudden signal attenuation occurs in high frequency ranges. A shielded cable has a shield conductor produced by helically winding a metal coated resin tape together around the circumference of a plurality of signal wires, upper and lower metal foils are in electrical contact with each other in overlap parts of the winding of the metal coated resin tape. The metal coated resin tape is formed with one edge part folded back so that the metal foil is disposed on an outward side. The overlap width of the winding of the metal coated resin tape is one-quarter to one-half of the tape width.

### BACKGROUND OF THE INVENTION

1. Technical Field

The present invention relates to a shielded cable having a metal coated resin tape for a shielding wound in a helix around the circumference of two or more signal wires.

2. Description of the Background Art

Shielded cables having a plurality (e.g., a pair) of signal wires are used in the transmission of digital signals in differential transmission systems. With differential signal transmission systems, signals with phases that have been inverted by 180° are input simultaneously into individual signal wires and transmitted. By detecting the signal differential between them on a receiving end thereof, the signal output can be doubled. In addition, noise incurred along the signal pathway extending from a transmission end to the receiving end is added equally to each of the pair of signal wires, resulting in characteristics whereby the noise is cancelled and eliminated when the differential signals are output on the receiving end.

In Japanese Patent Application Publication 2001-283649 (patent document 1), there is described a cable in which two core wires (signal wires) having center conductors (signal conductors) insulated with insulating bodies are covered by a shield conductor. The outer surface of the shield conductor is covered by a sheath produced by resin extrusion molding or winding with resin tape.

In this shielded cable, the shield conductor does not have sufficient strength and tends to be cut if only metal foil (e.g., aluminum foil) is used, so metal coated resin tape in which resin tape is clad with metal foil is commonly used. In this case, the metal coated resin tape is wound in an overlapping helix on the outer circumference of the signal wire, and the metal foil does not make electrical contact in the overlap parts. In addition, a longitudinal drain wire for ground connection is added between the signal wire and the metal coated resin tape so as to be in contact with the metal foil. However, with shielded cables having such a configuration, suck-out (precipitous loss of signal strength) arises at high frequencies of 3 GHz or greater, and there have been problems with drops in the signal level.

### DISCLOSURE OF THE INVENTION

The present invention relates to a shielded cable in which a plurality of signal wires are shielded by being helically wound together with metal coated resin tape, and an object of the present invention is to provide a shielded cable in which no sudden signal attenuation occurs in high-frequency ranges.

In order to attain the above objective, there is provided a shielded cable including (1) a plurality of signal wires, and (2) a shield conductor having metal coated resin tape that includes a metal foil affixed to a resin tape. The metal coated resin tape is helically wound around outer circumferential surface sections of the plurality of signal wires and defines a plurality of helix turnings, such that a first edge section of each helix turning of the metal coated resin tape overlaps with a second edge section of an adjacent helix turning of the metal coated resin tape forming an overlap part, with the first edge section and the second edge section being in electrical contact with each other in overlap part.

One of the first edge section and the second edge section of the overlap part of the metal coated resin tape may be folded back with the metal foil being exposed an outward side of the shield conductor. In one embodiment of this case, the metal coated resin tape may be wound so that the metal foil is on the inside and the metal foil of the overlap part is exposed outside and is in contact with the metal foil of the metal coated resin tape of the subsequent turn of the winding. In another embodiment of this case, the metal coated resin tape is wound so that the metal foil is on the outside and the metal foil of the overlap part is on the inside and is in contact with the metal foil of the metal coated resin tape of the prior turn of the winding.

The width (first width) of the metal foil of the metal coated resin tape may be greater than the width (second width) of the resin tape such that the second edge section includes only the metal foil and the first edge section overlaps the second edge section covering the second edge section. The width (third width) of the overlap part may be between one-quarter and one-half the size of the width (fourth width) of the metal coated resin tape. A shielded cable of the present invention may further include a drain wire disposed longitudinally in a manner in which the drain wire is in contact with the metal foil.

In accordance with the shielded tape of the present invention, it is possible to eliminate precipitous signal attenuation in high-frequency ranges.

### BRIEF DESCRIPTION OF THE DRAWINGS

FIG. 1A is an oblique view showing an embodiment of the shielded cable of the present invention, and FIG. 1B is an oblique view showing a modification example of the shielded cable of the present invention.

FIGS. 2A to 2D are diagrams depicting the metal coated resin tape in the shielded cable of FIG. 1A and the winding state thereof, where FIG. 2A is an oblique view, and FIGS. 2B to 2D are vertical sectional views.

FIG. 3A is a schematic view depicting the method for forming the fold back part of the metal coated resin tape shown in FIGS. 2B and 2C, FIG. 3B is a horizontal sectional view of the metal coated resin tape prior to folding over, and FIG. 3C is a horizontal sectional view after folding over of the metal coated resin tape.

FIGS. 4A and 4B are a perspective view and a horizontal sectional view of the metal coated resin tape shown in FIG. 2D.

FIGS. 5A and 5B, respectively, are graphs showing the frequency characteristics of signal attenuation in a conventional shielded cable and the shielded cable of an embodiment of the present invention.

### DETAILED DESCRIPTION OF THE INVENTION

The above-mentioned features and other features, aspects, and advantages of the present invention will be better understood through the following description, appended claims, and accompanying drawings. In the explanation of the drawings, an identical mark is applied to identical elements and overlapping explanations are omitted for the sake of brevity.

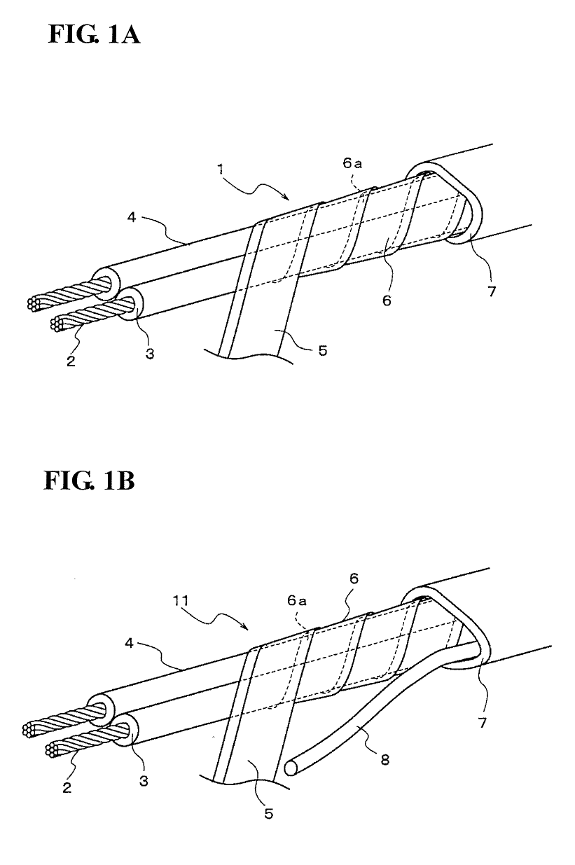

FIG. 1A is an oblique view showing the shielded cable 1 in an embodiment of the present invention. The shielded cable 1 includes two signal wires (or core wires) 4 in which a signal conductor 2 composed of a single core wire or a twisted wire is covered with an insulator 3. The two signal wires 4 can be aligned parallel to each other or can have a twisted paired cable configuration.

A metal coated resin tape 5 as a shield conductor 6 is helically wound around the outer circumference of a pair of two signal wires 4, and both of the two signal wires 4 are shielded. The metal coated resin tape 5, as described below, is wound to include overlapping sections so that the metal foil is faces outwardly in some embodiments and faces inwardly in other embodiments. Further, the metal foil is in electrical contact in overlap parts 6a. In some cases, the outside of the shield conductor 6 is covered with a sheath 7 in order to electrically insulate the wound metal coated resin tape 5, in order to prevent contamination, and in order to provide the cable with water resistance.

With the shielded cable of the present invention, a drain wire can be used. When the shield conductor is wound so that the metal face is inwards, the drain wire is disposed longitudinally between the signal wire 4 and the shield conductor 6. When the shield conductor 6 is wound so that the metal face is outwards, on the other hand, the drain wire 8 is disposed longitudinally between the shield conductor 6 and the sheath 7 (FIG. 1B). In both cases, the drain wire is in contact with the metal foil of the metal coated resin tape 5.

The signal conductor 2 in the shielded cable 1 or shielded cable 11 can be formed as a single-core wire or a twisted wire from copper, aluminum, or other good electrical conductor, or from a good electrical conductor that has been plated with tin or the like. For example, a wire corresponding to AWG 18 to 46 can be used. The conductor 3 is a material that has as low a dielectric constant as possible. For example, polyethylene (PE), ethyl vinyl acetate copolymer (EVA), fluororesins, or the like can be used. The outer diameter of the signal wire 4 that is formed from the wire material and insulating resin is 3.0 mm to 0.15 mm. For example, the outer diameter of the signal wire 4 is about 1.2 mm when AWG 26 wire material is used.

A material formed by laminating metal foil such as aluminum or copper onto a plastic substrate (resin tape) such as polyethylene terephthalate (PET) can be used as the metal coated resin tape 5 that forms the shield conductor 6. The thickness of the metal foil is 3 to 30 μm, the thickness of the plastic substrate is 3 to 50 μm, and the thickness of the metal coated resin tape 5 is 6 to 80 μm.

A sheath 7 for cable protection is provided on the outer circumference of the shield conductor 6. The sheath 7 can be formed by extrusion molding thermoplastic resin such as polyethylene, polyvinyl chloride, or fluororesin, or by winding onto the resin tape.

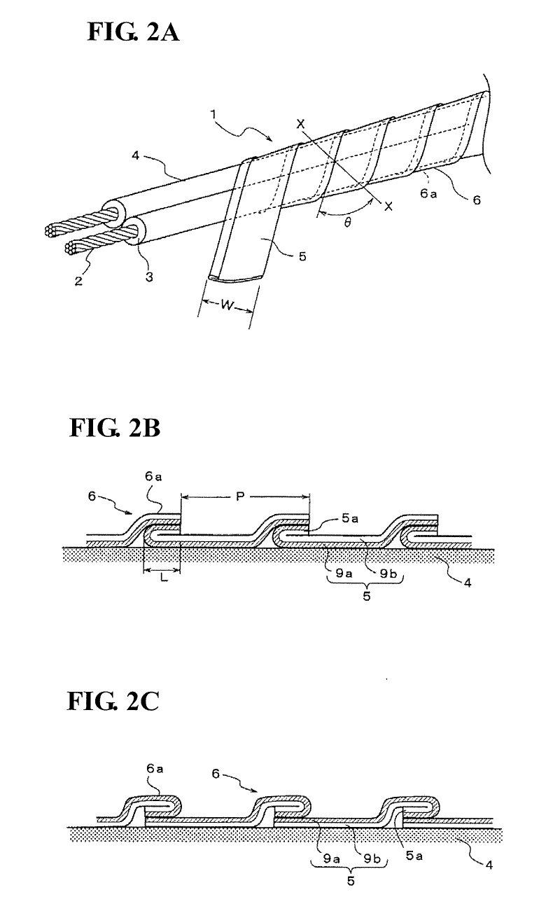

FIG. 2A is an oblique view that depicts the wound state of the metal coated resin tape 5 in the shielded cable 1. The metal coated resin tape 5 is wound in an overlapping helix on the outer circumference of a pair of signal wires 4, producing a shield conductor 6. The angle θ at which the metal coated resin tape 5 is overlapped and wound is 8 to 70° with respect to the X-X axis that is at a right angle to the longitudinal direction of the cable. The metal foil on the top and bottom is in electrical contact in the overlap parts 6a of the winding.

FIGS. 2B to 2D are vertical sectional views depicting an example of the metal coated resin tape and the wound condition thereof in the shielded cable 1. In FIG. 2B, in one edge part of the metal coated resin tape 5 having a resin tape 9b laminated to a metal foil 9a, the metal foil 9a is folded back outwards producing a folded overlap part 5a, the metal coated resin tape 5 is wound on the outer circumference of the signal wire 4 so that the metal foil 9a is on the inside. In this case, the metal foil 9a of the folded overlap part 5a is exposed outside the winding and is in contact with the metal foil 9a of the other edge that is on the opposite side from the folded back part of the metal coated resin tape of the subsequent turn of the winding, thereby producing an electrical connection.

The fold-back width L of the metal coated resin tape 5 is preferably about one-quarter to one-half the tape width W of the metal coated resin tape 5. The overlap width of the overlap part 6a is preferably approximately the same as the fold-back width L, or slightly longer. For example, if one edge of the metal coated resin tape with a width of 10 mm is folded back by 2 mm, then the tape width W is 8 mm, and the overlap width of the winding of the signal wire 4 is 2 to 2.3 mm. If the fold-back width is too small, then there can be insufficient conduction of the metal foil in the overlap parts, whereas if the fold-back width is too large, there will need excess metal coated resin tape and the wind can become disordered. The winding pitch P of the metal coated resin tape 5 is about 3 to 50 mm.

FIG. 2C is an example in which the metal coated resin tape 5 is wound on the outer circumference of the signal wire 4 so that the metal foil 9a is on the outside. In this case, the metal foil 9a of the folded overlap part 5a is on the inside of the winding and is in electrical contact through overlapping of the metal foil 9a on the opposite edge from the folded overlap part of the metal coated resin tape of the prior turn of the winding. The overlap width of the overlap part 6a of the shield conductor 6, the fold-back width L of the metal coated resin tape, the tape width W of the metal coated resin tape 5, the wind pitch P of the metal coated resin tape 5, and the like, can be the same as in the example of FIG. 2B.

FIG. 2D shows an example of the use of the metal resin tape 15 having an exposed foil part 5b in which the metal foil 9a has been exposed on the top and bottom surfaces by removing the resin tape 9b at the edge in advance. The metal coated resin tape 15 is wound on the outer circumference of the signal wire 4 so that the metal foil 9a is on the inside. The metal foil 9a of the other edge part on the subsequent turn of the winding overlaps the exposed foil part 5b of the previous turn of the winding, thereby producing an electrical connection. The metal coated resin tape 15 can also be wound on the outer circumference of the signal wire 4 so that the metal foil 9a is on the outside.

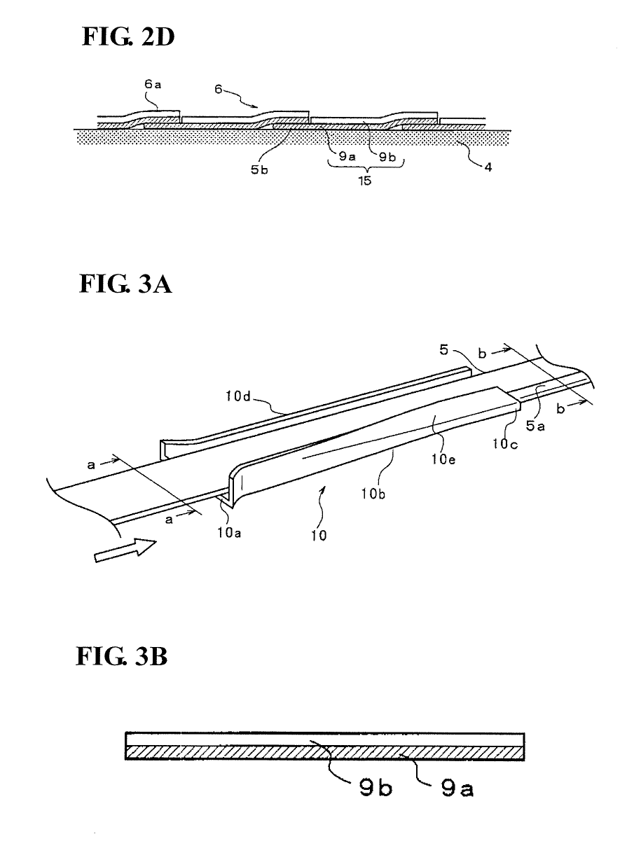

FIG. 3A is a schematic view depicting the method for forming the folded overlap part 5a of the metal coated resin tape 5. The folded overlap part 5a can be readily formed by using a forming jig 10. The forming jig 10 is composed of a tape intake part 10a, a tape folding part 10b, and a tape discharge part 10c. The tape intake part 10a is formed so as to widen outwards in order to guide the metal coated resin tape having a wide width prior to folding. The tape folding part 10b is formed from a straight guide wall 10d and a forming wall 10e that provides a separation with respect to the guide wall 10d that gradually narrows from the tape intake part 10a to the tape discharge part 10c, folding back so that it is parallel with respect to the bottom wall.

The metal coated resin tape (FIG. 3B) has the resin tape 9b that is laminated with the metal foil 9a having the same width as that of the resin tape 9b. With the tape folding part 10b, one of the edge parts of the metal coated resin tape is folded by the forming wall 10e, and when it reaches the side of the tape discharge part 10c, it has been worked by folding and overlapping so that the metal foil 9a is on the outside. At the tape discharge part 10c, the metal coated resin tape 5 (FIG. 3C) is produced in which the folded overlap part 5a has been formed on one edge.

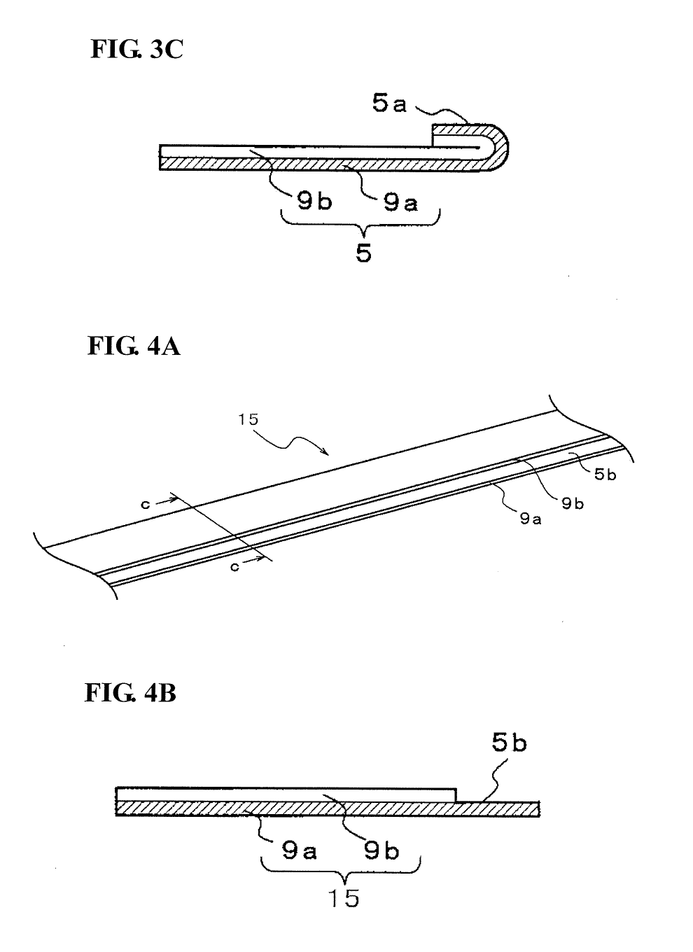

FIGS. 4A and 4B, respectively, are a perspective view and a horizontal sectional view of the metal coated resin tape 15. In the metal coated resin tape 15, by laminating the metal foil 9a and the resin tape 9b which has a narrower width than the width of the metal foil 9a, the inner surface of the metal foil 9a is exposed on one edge. Because the exposed foil part 5b has a lower strength and is more easily broken than the section where the metal foil 9a is laminated with the resin tape 9b, the metal coated resin tape 15 is suitable for cases in which a comparatively thick material is used for the metal foil 9a. In addition, as shown in FIG. 2D, this is suitable for cases in which the metal foil is wound so that as to be disposed on the inside.

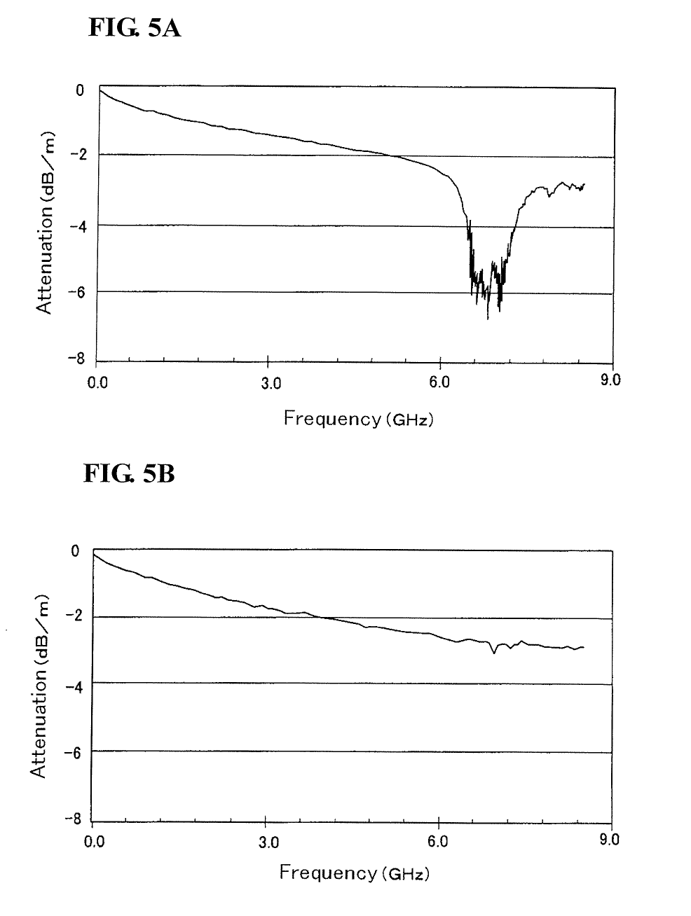

FIGS. 5A and 5B, respectively, are graphs showing the frequency characteristics of signal attenuation in a conventional shielded cable and a shielded cable of an embodiment of the present invention. The shielded cable is a twinax cable which has metal coated resin tape that is helically wound on two parallel signal wires. In the cable, PET tape is also wound over the metal coated resin tape, thereby simultaneously insulating and protecting the metal foil. FIG. 5A shows the signal attenuation characteristics in a conventional shielded cable in which the metal foil is not in contact in the overlap parts. FIG. 5B shows the signal attenuation characteristics in a shielded cable of the embodiment of FIG. 2C.

With the conventional shielded cable in which the winding pitch of the metal coated resin tape was 15 mm (FIG. 5A), a reduced signal occurred in the vicinity of 7 GHz. Although not shown, the relationship between frequency and loss was investigated with and without twisting of the signal wires and for different winding pitches. Suck-out occurred above 3 GHz with twin-core twisted cables, whereas suck-out occurred above 5 GHz with twin-core parallel cables.

In contrast, with the shielded cable of the embodiment of the present invention (FIG. 2C), it was found that signal attenuation was smooth, and no suck-out occurred. This may relate to the fact that whereas with conventional metal coated resin tapes, in which the upper and lower metal foils in the overlap parts between turns of the winding are electrically insulated by the resin layer the shield current accordingly flows helically across the circumference of the signal wire, in the present invention electrical contact is made between the upper and lower metal foils in the overlap parts between the turns of winding, so that the shield current flows in a linear fashion parallel to the signal wire.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims. For example, with the shielded cable 1, the signal wire 4 can be a coaxial wire in which the outer conductor outside the insulator 3 is a braid of metal wire, spirally wound metal wire, or wrapped metal coated resin tape. In addition, four signal wires can be used, with the four signal wires constituting a quad-cable.

What is claimed is:

1. A shielded cable comprising:
a plurality of signal wires; and
a shield conductor having metal coated resin tape that includes a metal foil affixed to a resin tape, the metal coated resin tape being helically wound around outer circumferential surface sections of the plurality of signal wires and defining a plurality of helix turnings, such that a first edge section of each helix turning of the metal coated resin tape overlaps with a second edge section of an adjacent helix turning of the metal coated resin tape forming an overlap part, with the first edge section and the second edge section being in electrical contact with each other in overlap part.

2. The shielded cable according to claim 1, wherein one of the first edge section and the second edge section of the overlap part of the metal coated resin tape is folded back with the metal foil being exposed an outward side of the shield conductor.

3. The shielded cable according to claim 2 wherein the metal coated resin tape is wound so that the metal foil is on the inside and the metal foil of the overlap part is exposed outside and is in contact with the metal foil of the metal coated resin tape of the subsequent turn of the winding.

4. The shielded cable according to claim 2, wherein the metal coated resin tape is wound so that the metal foil is on the outside and the metal foil of the overlap part is on the inside and is in contact with the metal foil of the metal coated resin tape of the prior turn of the winding.

5. The shielded cable according to claim 1, wherein the metal foil of the metal coated resin tape has a first width and the resin tape has a second width, the first width being greater than the second width such that the second edge section includes only the metal foil and the first edge section overlaps the second edge section covering the second edge section.

6. The shielded cable according to claim 1, wherein the overlap part has a third width and the metal coated resin tape has a fourth width such that the third width is between one-quarter and one-half the size of the fourth width.

7. The shielded cable according to claim 1, further comprising a drain wire disposed longitudinally in a manner in which the drain wire is in contact with the metal foil.
